(19) United States
(12) Patent Application Publication
(10) Pub. No.: US 2017/0098886 A1
(43) Pub. Date: Apr. 6, 2017

(54) ANTENNA DEVICE AND INFORMATION PROCESSING APPARATUS

(71) Applicant: FUJITSU LIMITED, Kawasaki-shi (JP)

(72) Inventor: MASARU KANAZAWA, Kawasaki (JP)

(73) Assignee: FUJITSU LIMITED, Kawasaki-shi (JP)

(21) Appl. No.: 15/262,492

(22) Filed: Sep. 12, 2016

(30) Foreign Application Priority Data
Oct. 6, 2015 (JP) 2015-198438

(51) Int. Cl. H01Q 1/24; H01Q 1/50; H01Q 13/08; H01Q 1/48

(52) U.S. Cl. CPC H01Q 1/243; H01Q 1/48; H01Q 1/50; H01Q 13/085

(57) ABSTRACT

A notch antenna is a bored-through groove formed on a housing, is open on one end at an edge of the housing, and is closed on the other end. A slot antenna is a bored-through groove closed on both ends, is adjacent to the notch antenna on the housing, and extends in the extending direction of the other end of the notch antenna. A feeding point is disposed in the vicinity of the slot antenna on the housing on the opposite side to the other end portion of the notch antenna. An outer conductor is disposed in the vicinity of the other end of the notch antenna on the housing on the opposite side to the slot antenna.

### CROSS-REFERENCE TO RELATED APPLICATION

This application is based upon and claims the benefit of priority of the prior Japanese Patent Application No. 2015-198438, filed on Oct. 6, 2015, the entire contents of which are incorporated herein by reference.

### FIELD

The embodiments discussed herein are related to an antenna device and an information processing apparatus.

BACKGROUND

In recent years, in a small information processing apparatus such as a tablet personal computer (PC) and a notebook PC, further downsizing and thinning have been advancing. In such an information processing apparatus, it is getting difficult to secure a wide antenna area.

Antennas commonly used in information processing apparatuses include a monopole antenna and an inverted-F antenna. With these antennas, to secure adequate communication characteristics, the antenna and a ground (GND) are placed at remote positions.

Furthermore, when an antenna overlaps with metal, the communication characteristics of the antenna deteriorate. Accordingly, the antenna is arranged in an area in which the antenna does not overlap with a metal cover and active areas of a display and a touch panel. The housing of a data communication terminal is often made of metal to ensure strength. However, even with such a housing made of metal, to avoid the influence of the metal, a portion that overlaps with the antenna is made of resin.

Meanwhile, in addition to monopole antennas and inverted-F antennas, it is conceivable, by providing a cut on a metal plate, to use the metal plate as antennas. These antennas include a slot antenna provided with a cut not having an opening at the edge of the metal plate and a notch antenna provided with a cut extending from an opening at the edge of the metal plate.

Moreover, as the frequency band used in wireless fidelity (WiFi, registered trademark) that is often used as a communication method of information processing apparatuses, there are two frequency bands of 2.4 GHz and 5 GHz. Accordingly, it is preferable that the antenna fitted to the information processing apparatus support those two frequency bands used in WiFi.

As technologies that use slot antennas and notch antennas, available is a conventional technology that obtains two resonant frequencies by providing a slot antenna on a conductive frame of a computer and dividing the slot into two areas by a feeding point disposed on the side of the slot. Furthermore, a conventional technology that obtains different resonant frequencies by arranging two slots of different lengths on a conductive substrate is available.

Patent Document 1: Japanese Laid-open Patent Publication No. 2014-533454

Patent Document 2: Japanese Laid-open Patent Publication No. 2004-336180

Meanwhile, when the antenna and the ground are placed at remote positions and when the antenna is arranged such that the antenna does not overlap with the metal cover and the active areas of the display and the touch panel, it is likely to increase the size of the apparatus.

Accordingly, to reduce the size of the apparatus, it is conceivable to provide a slot antenna or a notch antenna on a metal cover. However, even when a single slot antenna or a notch antenna is provided on the metal cover, the range of resonant frequency is narrow and it is difficult to support the intended frequency bands.

Furthermore, even when the conventional technology that disposes the feeding point on the side of the slot is used, the combination of resonant frequencies obtainable is limited and it is difficult to obtain the resonant frequencies corresponding to the intended frequency bands. Even when the conventional technology that arranges two slots is used, in order to obtain a resonant frequency corresponding to the intended frequency band, it ends up using a long slot, and thus it is difficult to keep the size of the apparatus small. Moreover, when a notch antenna and a slot antenna are simply provided on a metal cover, power consumption may increase to obtain a radio wave of an intended strength.

### SUMMARY

According to an aspect of an embodiment, an antenna device includes: a first slit that is a bored-through groove formed on a metal plate, is open on one end at an edge of the metal plate, and is closed on the other end; a second slit that is a bored-through groove closed on both ends, is adjacent to the first slit on the metal plate, and extends in an extending direction of the other end of the first slit; a feeding point that is disposed in vicinity of the second slit on the metal plate on an opposite side to a portion of the other end of the first slit; and a ground that is disposed in vicinity of the other end of the first slit on the metal plate on an opposite side to the second slit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a plan view of a notebook PC according to a first embodiment;

FIG. 2 is a schematic diagram of an antenna device in the first embodiment;

FIG. 3 is a diagram for explaining the flow of electric current in the antenna device in the first embodiment;

FIG. 4 is a diagram for explaining the flow of electric current in the case of having swapped the positions of a notch antenna and a slot antenna;

FIG. 5 is a chart illustrating a VSWR in the case of a notch antenna alone;

FIG. 6 is a chart illustrating the VSWR in the case of a slot antenna alone;

FIG. 7 is a chart illustrating the VSWR of the antenna device in the first embodiment;

FIG. 8 is a chart illustrating the VSWR in the case of having swapped the positions of the notch antenna and the slot antenna;

FIG. 9 is a schematic diagram of an antenna device according to a second embodiment;

FIG. 10 is a schematic diagram of an antenna device according to a third embodiment; and

FIG. 11 is a schematic diagram of an antenna device in which an open end of a notch antenna is closed with a dielectric.

### DESCRIPTION OF EMBODIMENTS

Preferred embodiments of the present invention will be explained with reference to accompanying drawings. Note that the antenna device and the information processing apparatus disclosed in the present application are not limited by the following exemplary embodiments.

### [a] First Embodiment

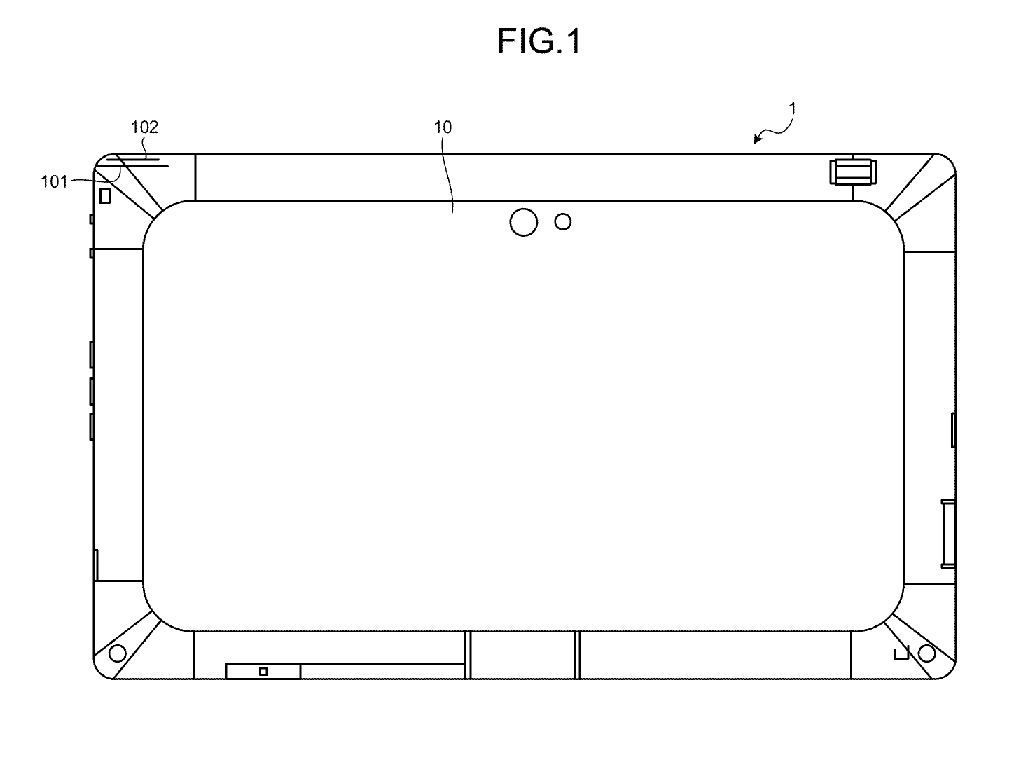

FIG. 1 is a plan view of a notebook PC according to a first embodiment. In a notebook PC 1 in the first embodiment, a housing 10 is made of metal such as magnesium. The notebook PC 1 is one example of “information processing apparatus.”

The housing 10 in the first embodiment has a notch antenna 101 and a slot antenna 102 at an end portion on the upper left in FIG. 1. Both the notch antenna 101 and the slot antenna 102 are bored-through grooves that penetrate a metal plate forming an upper portion of the housing 10. The housing 10 is one example of “metal plate.”

In the notch antenna 101, one end portion of the groove extends to the edge of the housing 10 and is an open end. The other end portion of the groove that the notch antenna 101 forms terminates on the metal plate forming the housing 10 and is a short-circuited end. In the first embodiment, the notch antenna 101 has a linear shape. The notch antenna 101 is one example of “first slit.”

In the slot antenna 102, both end portions of the groove are short-circuited ends that terminate on the metal plate forming the housing 10. The slot antenna 102 has a linear shape. The slot antenna 102 is arranged in juxtaposition such that the extending direction of the groove is in parallel with the extending direction of the groove of the notch antenna 101. The slot antenna 102 is one example of “second slit.”

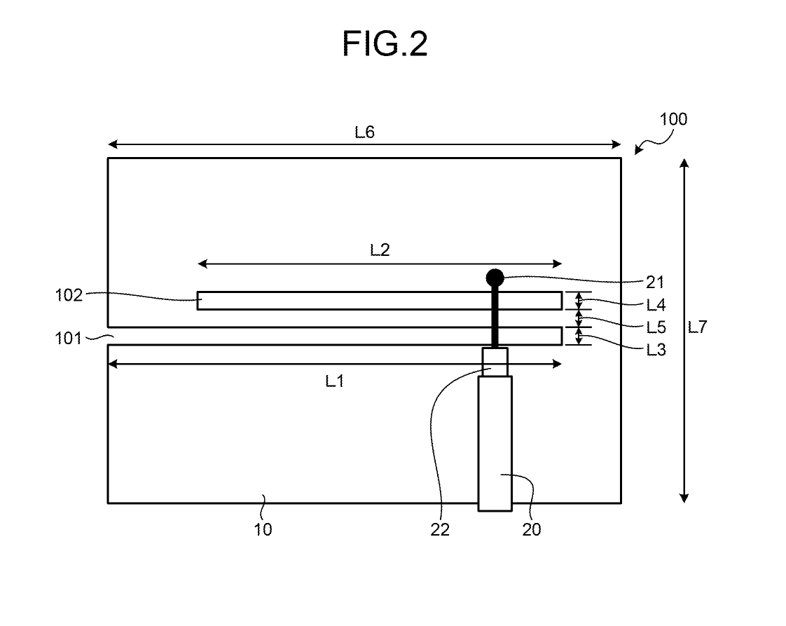

Next, with reference to FIG. 2, power feeding to the notch antenna 101 and the slot antenna 102 in the notebook PC 1 in the first embodiment will be described. FIG. 2 is a schematic diagram of an antenna device in the first embodiment. An antenna device 100 illustrated in FIG. 2 corresponds to an area including the notch antenna 101 and the slot antenna 102 of the housing 10 and cut out from FIG. 1.

As illustrated in FIG. 2, in the antenna device 100 in the first embodiment, the power feeding is carried out with a coaxial cable 20. In the vicinity of the slot antenna 102 on the opposite side to the notch antenna 101, a feeding point 21 is disposed. The feeding point 21 is connected to the housing 10.

Furthermore, in the vicinity of the notch antenna 101 on the opposite side to the slot antenna 102, an outer conductor 22 that is a ground of the coaxial cable 20 is disposed. The outer conductor 22 also is connected to the housing 10.

By an electric current that is output from the feeding point 21 flowing toward the outer conductor 22, an electric field is generated to the slot antenna 102. Accordingly, the slot antenna 102 resonates to a radio wave having a wavelength (λ) of twice the length of the slit.

Moreover, by the electric current that is output from the feeding point 21 flowing toward the outer conductor 22, an electric field is generated to the notch antenna 101. Accordingly, the notch antenna 101 resonates to a radio wave having a wavelength (λ) of four times the length of the slit.

The dimensions of the antenna device 100 are determined as in FIG. 2. That is, it is defined as a square in which the length L6 of one side of the metal plate representing a part of the housing 10 that composes the antenna device 100 is 90 mm and the length L7 of the other side is 90 mm. Furthermore, the length L1 of the groove of the notch antenna 101 is defined as 30 mm. The length L2 of the groove of the slot antenna 102 is defined as 25 mm. Each of the length L3 of the notch antenna 101 in the short direction, the length L4 of the slot antenna 102 in the short direction, and the distance L5 between the notch antenna 101 and the slot antenna 102 is defined as 1 mm.

In this case, the notch antenna 101 obtains a resonant frequency of 2.4 GHz. The slot antenna 102 obtains a resonant frequency of 5 GHz. In other words, the antenna device 100 is able to perform communication at two frequencies of 2.4 GHz and 5 GHz used in WiFi.

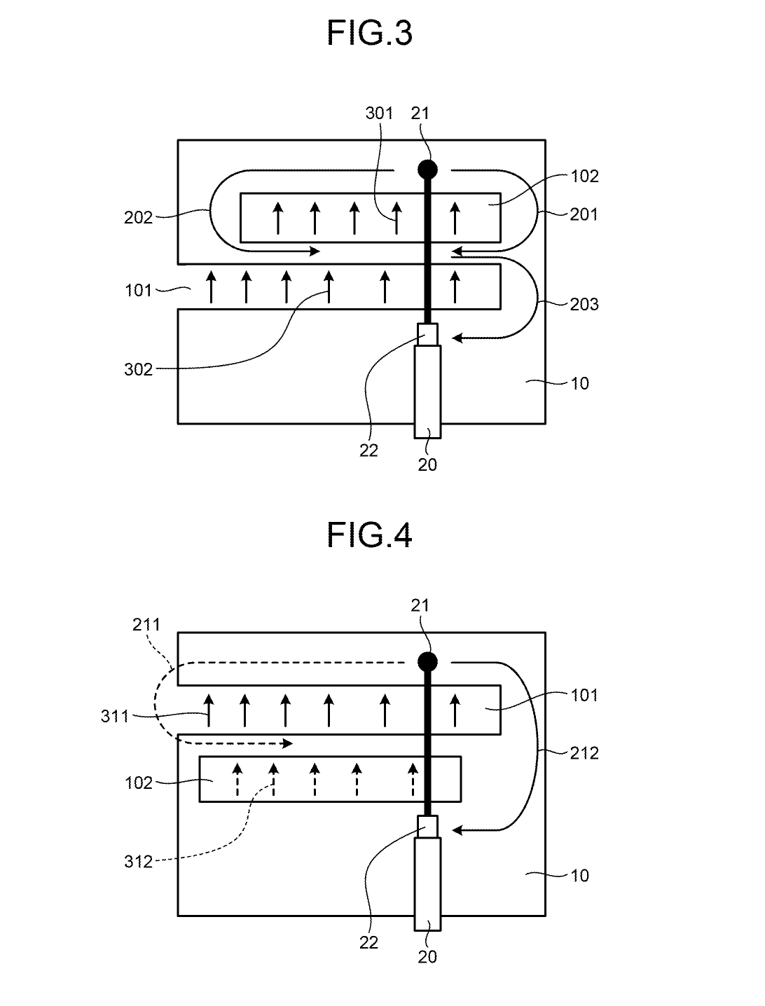

With reference to FIG. 3, the flow of electric current in the antenna device 100 in the first embodiment will be further described. FIG. 3 is a diagram for explaining the flow of electric current in the antenna device in the first embodiment.

The electric current output from the feeding point 21 advances as in paths 201 and 202. In other words, the electric current flows around the slot antenna 102. Accordingly, an electric field 301 is generated to the slot antenna 102. Then, by the generation of the electric field 301, the slot antenna 102 resonates.

Furthermore, the electric current that has passed the surrounding of the slot antenna 102 advances as in a path 203 and reaches the outer conductor 22. Via the path 203, an electric current flows between the slot antenna 102 and the notch antenna 101. Moreover, via the path 203, the electric current flows to an area of the notch antenna 101 on the opposite side to the slot antenna 102. In other words, the electric current flows around the notch antenna 101. Accordingly, an electric field 302 is generated to the notch antenna 101. Then, by the generation of the electric field 302, the notch antenna 101 resonates.

In contrast, a situation of having swapped the positions of the notch antenna 101 and the slot antenna 102 will be considered. FIG. 4 is a diagram for explaining the flow of electric current in the case of having swapped the positions of the notch antenna and the slot antenna.

When the positions of the notch antenna 101 and the slot antenna 102 are swapped, the feeding point 21 is disposed in the vicinity of the notch antenna 101 on the opposite side to the slot antenna 102 as illustrated in FIG. 4. Furthermore, the outer conductor 22 is disposed in the vicinity of the slot antenna 102 on the opposite side to the notch antenna 101.

In this case, the electric current output from the feeding point 21 advances as in a path 212. In this case, by the open end of the notch antenna 101, a path 211 in FIG. 4 is interrupted. Consequently, it is difficult for the electric current output from the feeding point 21 to flow through as in the path 211.

In this process, by the flow of the path 212, because an electric current flows around the notch antenna 101, an electric field 311 is generated to the notch antenna 101. Then, by the generation of the electric field 311, the notch antenna 101 resonates.

Meanwhile, because the electric current does not flow through as in the path 211, the electric current does not flow between the notch antenna 101 and the slot antenna 102. That is, an electric field 312 is not generated to the slot antenna 102. Thus, the slot antenna 102 does not resonate.

Consequently, when the positions of the notch antenna 101 and the slot antenna 102 are arranged as in FIG. 4, the antenna device supports only the communication at the resonant frequency of the notch antenna 101.

In other words, as in the antenna device 100 in the first embodiment, by arranging the feeding point 21, the slot antenna 102, the notch antenna 101, and the outer conductor 22 in order of the foregoing, the antenna device 100 is able to perform communication using the two frequency bands used in WiFi.

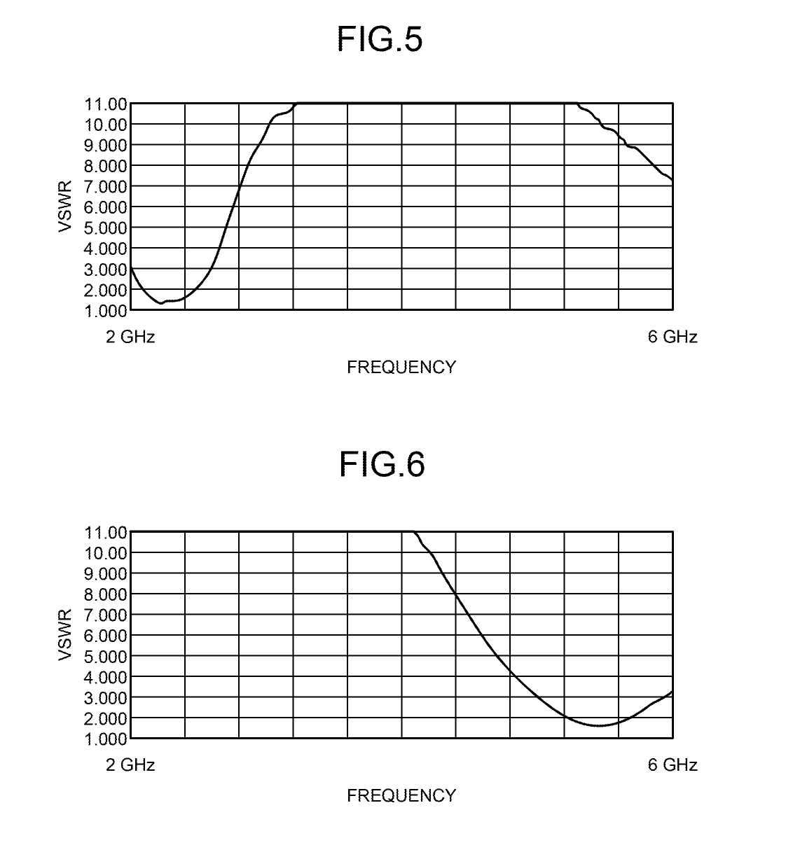

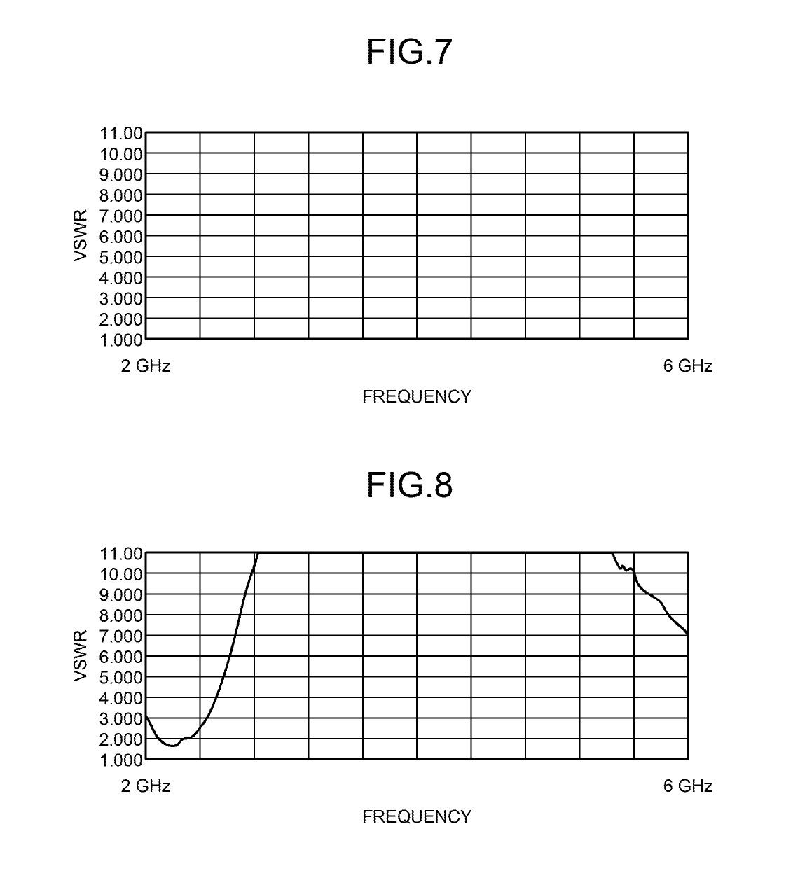

Next, with reference to FIGS. 5 to 8, the comparison of voltage standing wave ratio (VSWR) between when the antenna device 100 in the first embodiment is used and when in other conditions will be described. FIG. 5 is a chart illustrating the VSWR in the case of a notch antenna alone. FIG. 6 is a chart illustrating the VSWR in the case of a slot antenna alone. FIG. 7 is a chart illustrating the VSWR of the antenna device in the first embodiment. FIG. 8 is a chart illustrating the VSWR in the case of having swapped the positions of the notch antenna and the slot antenna. In all of FIGS. 5 to 8, the ordinate axis represents VSWR and the abscissa axis represents frequency.

FIG. 7 is a result of simulation performed by using the antenna device 100 of the configuration illustrated in FIG. 2. FIG. 5 is a result of simulation performed by using an antenna device in which the slot antenna 102 has been removed from the antenna device 100 illustrated in FIG. 2. FIG. 6 is a result of simulation performed by using an antenna device in which the notch antenna 101 has been removed from the antenna device 100 illustrated in FIG. 2. FIG. 8 is a result of simulation performed by using an antenna device in which the positions of the notch antenna 101 and the slot antenna 102 of the antenna device 100 illustrated in FIG. 2 have been swapped.

As illustrated in FIG. 5, in the case of the notch antenna 101 alone, the VSWR is minimized in the vicinity of 2.4 GHz and is in good characteristics. That is, the antenna device of the notch antenna 101 alone can define only the vicinity of 2.4 GHz as a frequency to use.

As illustrated in FIG. 6, in the case of the slot antenna 102 alone, the VSWR is minimized in the vicinity of 5 GHz and is in good characteristics. That is, the antenna device of the slot antenna 102 alone can define only the vicinity of 5 GHz as a frequency to use.

As just described, the antenna device that has only one of either the notch antenna 101 or the slot antenna 102 supports only the communication that uses either one of the frequency bands out of the two frequency bands used in WiFi.

In contrast, as illustrated in FIG. 7, in the antenna device 100 in the first embodiment, the VSWR is low in the vicinity of 2.4 GHz and in the vicinity of 5 GHz and is in good characteristics. That is, the antenna device 100 in the first embodiment can define both the vicinity of 2.4 GHz and the vicinity of 5 GHz as frequencies to use. Accordingly, the antenna device 100 in the first embodiment can support communication using both the two frequency bands used in WiFi.

Meanwhile, as illustrated in FIG. 8, in the case of swapping the notch antenna 101 and the slot antenna 102, while the VSWR is sufficiently lowered in the vicinity of 2.4 GHz and is in good characteristics, the VSWR is not lowered in the vicinity of 5 GHz and the characteristics are deteriorated. That is, the antenna device in which the notch antenna 101 and the slot antenna 102 are swapped can define only the vicinity of 2.4 GHz as a frequency to use. Consequently, it can be found that, unless the notch antenna 101, the slot antenna 102, the feeding point 21, and the outer conductor 22 are arranged as in the antenna device 100 in the first embodiment, it is difficult to support the communication using both the two frequency bands used in WiFi.

In the above-described explanation, the housing 10 composed of magnesium has been exemplified. However, as long as it is the metal of good electric conductivity, other metal can be used as a metal plate of the antenna device 100. For example, copper (Cu) and others can also be used.

As in the foregoing, the antenna device in the first embodiment can perform communication by using two frequency bands by combining the notch antenna and the slot antenna, and can obtain intended resonant frequencies. Furthermore, the use of the notch antenna as an antenna that resonates to a low frequency can shorten the length of the slit and can downsize the antenna.

In the antenna device in the first embodiment, because the flow of electric current is not interrupted by the open end of the notch antenna, the electric current is likely to flow through both the notch antenna and the slot antenna. Thus, the radio wave of an intended strength can be output with a small amount of power feeding, and the power consumption can be reduced.

### [b] Second Embodiment

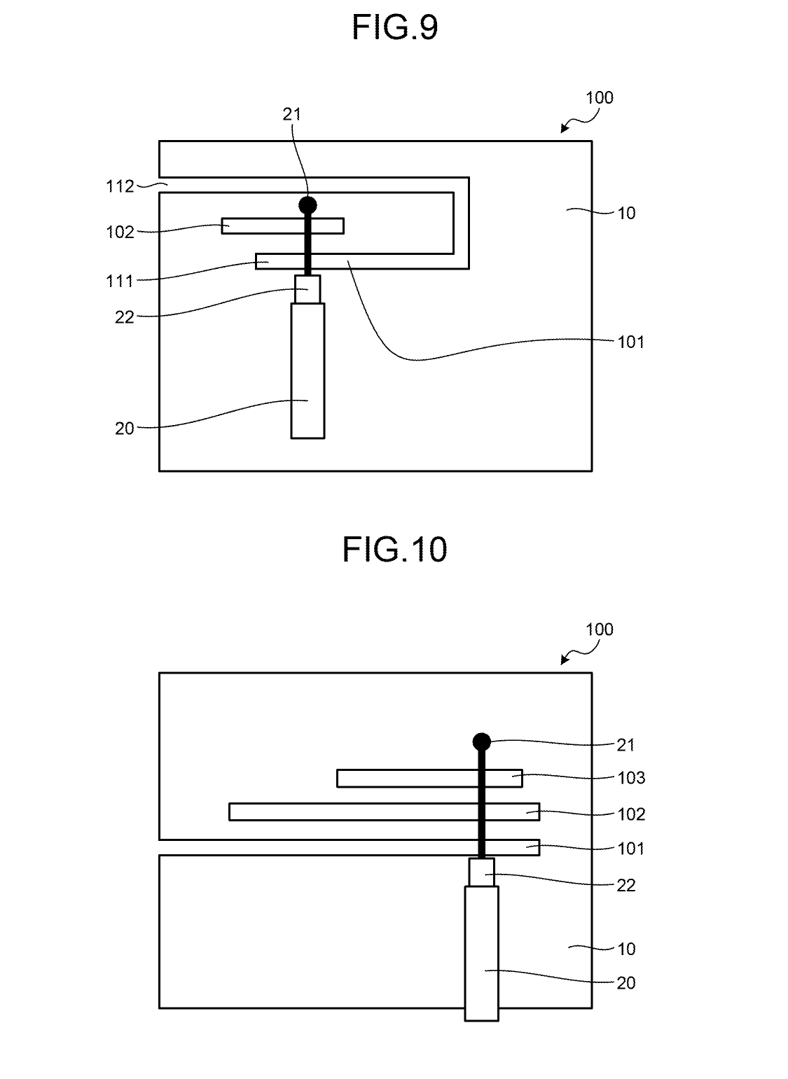

FIG. 9 is a schematic diagram of an antenna device according to a second embodiment. The antenna device 100 in the second embodiment is different from that of the first embodiment in that the notch antenna 101 has a bent shape. In the following description, the descriptions on the various portions having the same functions as those in the first embodiment are omitted.

In the notch antenna 101 in the second embodiment, a slit extends in parallel with the slot antenna 102 from a short-circuited end 111, bends within the metal plate, advances in the reverse direction, extends up to the end portion of the housing 10, and forms an open end 112.

That is, the notch antenna 101 has a U-shaped shape surrounding one end of the groove of the slot antenna 102, and one end of the U-shape is the open end 112 and the other end of the U-shape is the short-circuited end 111.

Even when the notch antenna 101 has such a shape, the electric current that is output from the feeding point 21 flows through both the slot antenna 102 and the notch antenna 101 without being interrupted by the open end 112 and generates respective electric fields to both antennas. That is, the antenna device 100 in the second embodiment also can define both the vicinity of 2.4 GHz and the vicinity of 5 GHz as frequencies to use. Accordingly, the antenna device 100 in the second embodiment can support communication using both the two frequency bands used in WiFi.

As in the foregoing, in the antenna device in the second embodiment, the notch antenna is made into a U-shaped shape by bending. Accordingly, the antenna device in the second embodiment can make the size smaller.

Furthermore, in the second embodiment, the notch antenna 101 has been made into a U-shape. However, as long as the side extending from the short-circuited end 111 is in parallel with the slot antenna 102 and there is no slit connecting to the open end 112 between the notch antenna 101 and the slot antenna 102, the notch antenna 101 may be in other shapes.

### [c] Third Embodiment

FIG. 10 is a schematic diagram of an antenna device according to a third embodiment. The antenna device 100 in the third embodiment is different from that of the first embodiment in that a plurality of slot antennas 102 and 103 are arranged between the notch antenna 101 and the feeding point 21. In the following description, the descriptions on the various portions having the same functions as those in the first embodiment are omitted.

In the antenna device 100 in the third embodiment, between the slot antenna 102 and the feeding point 21, a slot antenna 103 is arranged in parallel with the slot antenna 102.

The slot antenna 103 has a length different from that of the slot antenna 102. That is, the resonant frequency of the slot antenna 103 is different from that of the slot antenna 102. Furthermore, the resonant frequency of the slot antenna 103 is designed to be also different from the resonant frequency of the notch antenna 101.

The slot antenna 103 has no open end. Thus, the electric current that is output from the feeding point 21 can flow around the slot antennas 102 and 103 without being interrupted by an open end. Accordingly, electric fields are generated to all of the slot antennas 102 and 103 and the notch antenna 101.

That is, the antenna device 100 in the third embodiment can perform communication at respective resonant frequencies of the slot antennas 102 and 103 and the notch antenna 101. The slot antenna 103 is one example of “third slit.”

As in the foregoing, the antenna device in the third embodiment can support communication using three frequency bands.

In the third embodiment, two slot antennas have been provided. However, as long as being provided between the feeding point and the notch antenna, the number of slot antennas is not limited in particular. In that case, corresponding to the number of provided slot antennas, the number of resonant frequencies of the antenna device increases.

Furthermore, in the third embodiment, the notch antenna of a linear shape has been used. However, the notch antenna having a bent shape that has been described in the second embodiment may be used. In that case, the slit connecting to the open end of the notch antenna is arranged such that the slit passes through places other than the place between the feeding point and the slot antennas.

Moreover, in each of the foregoing embodiments, a situation of carrying out the power feeding by using the coaxial cable has been exemplified. However, the method of power feeding is not limited to this. For example, ones for which the characteristic impedance can be controlled, such as a semi-rigid cable and a microstrip line, can be used for power feeding.

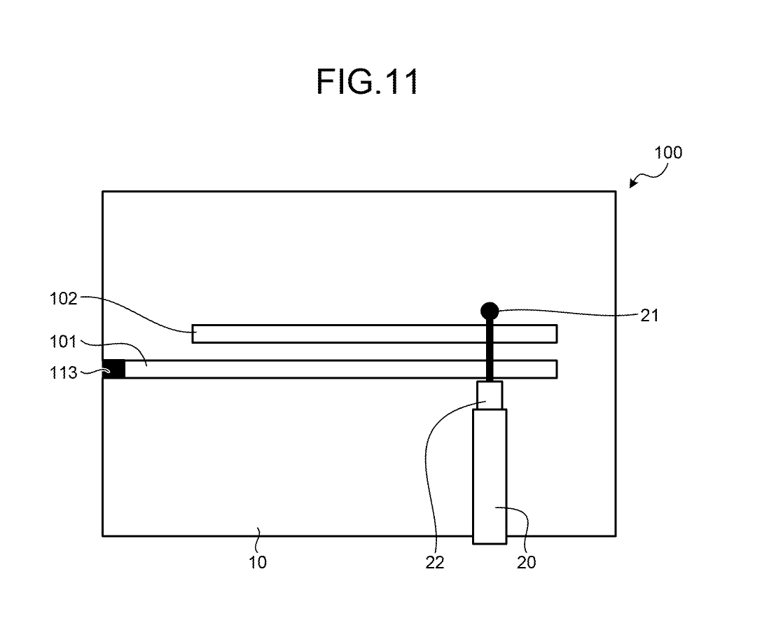

In each of the foregoing embodiments, the open end of the notch antenna 101 has been physically open. However, the open end only needs to be open electrically. For example, as illustrated in FIG. 11, in the notch antenna 101 provided on the antenna device 100, a portion of the open end may be physically closed with a dielectric 113 other than metal that deteriorates the antenna characteristics. FIG. 11 is a schematic diagram of an antenna device in which the open end of the notch antenna is closed with a dielectric. As for the dielectric 113, resin material such as acrylonitrile butadiene styrene (ABS) resin, epoxy resin, and vinylidene chloride resin can be used, for example. That is, the notch antenna 101 may, by closing the open end with the dielectric 113, be formed in the same shape as that of the slot antenna 102 physically.

One aspect of the antenna device and the information processing apparatus disclosed in the present application provides an advantageous effect in that an intended frequency band can be covered with reduced power consumption.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An antenna device comprising:
a first slit that is a bored-through groove formed on a metal plate, is open on one end at an edge of the metal plate, and is closed on the other end;
a second slit that is a bored-through groove closed on both ends, is adjacent to the first slit on the metal plate, and extends in an extending direction of the other end of the first slit;
a feeding point that is disposed in vicinity of the second slit on the metal plate on an opposite side to a portion of the other end of the first slit; and
a ground that is disposed in vicinity of the other end of the first slit on the metal plate on an opposite side to the second slit.

2. The antenna device according to claim 1, wherein
the first slit resonates to a first frequency, and
the second slit resonates to a second frequency that is larger than the first frequency.

3. The antenna device according to claim 1, further comprising a third slit that is a bored-through groove formed between the second slit and the feeding point on the metal plate and extending in an extending direction of the second slit, the third slit being a single slit or a plurality of slits closed on both ends.

4. The antenna device according to claim 1, wherein the first slit is a U-shaped groove that surrounds the second slit and the feeding point.

5. An image processing apparatus comprising:
a housing made of metal;
a first slit that is a bored-through groove formed on the housing, is open on one end at an edge of the housing, and is closed on the other end;
a second slit that is a bored-through groove closed on both ends, is adjacent to the first slit on the housing, and extends in an extending direction of the other end of the first slit;
a feeding point that is disposed in vicinity of the second slit on the housing on an opposite side to a portion of the other end of the first slit; and
a ground that is disposed in vicinity of the other end of the first slit on the housing on an opposite side to the second slit.
